(19) United States
(12) Patent Application Publication
(10) Pub. No.: US 2017/0259470 A1
(43) Pub. Date: Sep. 14, 2017

(54) METHOD OF PRODUCING A DECORATIVE STRUCTURAL PLASTIC PART

(71) Applicant: FORD GLOBAL TECHNOLOGIES, LLC, Dearborn, MI (US)

(72) Inventors: Robert Duane Bedard, Allen Park, MI (US); George David Koch Smith, Lake Orion, MI (US)

(21) Appl. No.: 15/065,372

(22) Filed: Mar. 9, 2016

(51) Int. Cl. B29C 43/14; B29C 45/16

(52) U.S. Cl. CPC B29C 43/146; B29C 45/1615; B29K 2079/00

(57) ABSTRACT

A method is provided for producing a decorative structural plastic part. That method includes the steps of two-shot molding a structural plastic layer with a decoration-compatible plastic layer, mechanically bonding the structural plastic layer with the decoration-compatible plastic layer to form an integral plastic part body and applying a decoration to the decoration-compatible plastic layer following molding.

### TECHNICAL FIELD

This document relates generally to the production of decorative structural plastic parts and, more particularly, to the production of an automotive air register louver by means of two-shot molding of an integral plastic part body followed by application of a decoration to the integral plastic part body outside of the mold.

### BACKGROUND

Air registers, which are responsible for directing air flow to the vehicle occupants, are also important aesthetic elements that contribute to the overall style and theme of an automotive cockpit. FIG. 1 illustrates one technique used in the industry for decorating air register louvers. In this technique, the body B of the louver L is formed from a structural plastic resin such as glass-filled polyamide. That structural plastic resin cannot properly accept a decoration such as a metalized film or foil directly. Therefore, a separate cap C is molded from a non-structural resin/decoration-compatible material that will accept the decoration D. That separate cap C is then manually installed and adhesively bonded to the polyamide louver to provide the decorative appearance. More specifically, the lug G formed on the polyamide body B is pressed into and received in the notch N formed in the cap C. An adhesive A bonds the cap C and body B together. As should be appreciated, this louver manufacturing process comprises multiple component parts and steps which increase production costs and inherently include a large number of failure modes.

This document presents an innovative method for marrying a decoration with structural resins wherein a structural plastic resin and a decoration-compatible plastic resin are injected into a mold to form an integral plastic part body. That integral plastic part body is then removed from the mold and a decoration is applied to the decoration-compatible plastic resin of the body.

### SUMMARY

In accordance with the purposes and benefits described herein, a method is provided for producing a decorative structural plastic part such as, for example, an air register louver or vane. That method may be broadly described as comprising the steps of: (a) two-shot molding a structural plastic layer with a decoration-compatible plastic layer, (b) mechanically bonding the structural plastic layer with the decoration-compatible plastic layer to form an integral plastic part body and (c) applying a decoration to the decoration-compatible plastic layer following molding.

In one possible embodiment, that method may also include injecting a structural plastic resin into a mold to form a structural plastic layer. This is followed by the step of injecting a decoration-compatible plastic resin into the mold against the structural plastic layer to form the decoration-compatible plastic layer and the integral plastic part body. Next are the steps of removing the integral plastic part body from the mold and applying the decoration to the decoration-compatible plastic layer. In addition, the method may include using heat and pressure to apply the decoration to the decoration-compatible plastic layer.

In accordance with another possible embodiment, the method may include injecting a decoration-compatible plastic resin into a mold to form the decoration-compatible plastic body. This is followed by injecting a structural plastic resin into the mold against the decoration-compatible plastic layer to form the structural plastic layer and the integral plastic part body. Next is the removing of the integral plastic part body from the mold followed by applying the decoration to the decoration-compatible plastic layer.

In accordance with an additional aspect, the method of producing a decorative structural plastic part may include the steps of closing a mold, including a first mold section and a second mold section. This is followed by injecting a structural plastic resin into the closed mold to form a structural plastic layer. Next is the opening of the mold while retaining the structural plastic layer in the second mold section. This is followed by replacing the first mold section with a third mold section and closing the mold. Next is the injecting of a decoration-compatible plastic resin into the mold between the structural plastic layer and the third mold section to form an integral plastic part body including the structural plastic layer and a decoration-compatible plastic layer.

In addition, the method includes mechanically bonding the structural plastic layer with the decoration-compatible plastic layer during molding. This is followed by the opening of the mold and the removing of the integral plastic part body from the mold. Finally, the method includes the step of applying a decoration to the decoration-compatible plastic layer after the integral plastic part body is removed from the mold.

More specifically, the method may include the step of forming a mechanical bond between the structural plastic layer and the decoration-compatible plastic layer by providing a first set of alternating projections and channels on a first face of the structural plastic layer. In addition the method may include forming a second set of alternating projections and channels on a second face of the decoration-compatible plastic layer. Further the method may include interdigitating the first set of alternating projections and channels with the second set of alternating projections and channels so as to form a strong mechanical bond between the structural plastic layer and the decoration-compatible layer. Those interdigitating sets of projections and channels may be provided in a dovetail configuration in some embodiments.

Still further, the method may include molding the structural plastic layer from a structural plastic resin selected from a group consisting of 50% glass-filled polyamide 6 (PA6), 60% glass-filled polyamide 6 (PA6), 50% glass-filled polyamide 66 (PA66), 60% glass-filled polyamide 66 (PA66), 55% glass-filled polybutylene terephthalate (PBT) or mixtures thereof. In addition, the method may include molding the decoration-compatible plastic layer from a decoration-compatible resin selected from a group consisting of acrylonitrile butadiene styrene (ABS), polycarbonate+acrylonitrile butadiene styrene (PC+ABS), acrylonitrile styrene acrylate (ASA) or mixtures thereof.

In one possible embodiment, decorative foil is used as the decoration. In another possible embodiment, decorative film is used as the decoration. In any embodiment, the decoration is compatible and will bind securely with the decoration-compatible plastic layer upon the application of the necessary heat and pressure.

In the following description, there are shown and described several preferred embodiments of the method. As it should be realized, the method is capable of other, different embodiments and its several details are capable of modification in various, obvious aspects all without departing from the method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the method and together with the description serve to explain certain principles thereof. In the drawing figures:

FIG. 1 is a schematic illustration of a conventional air register louver constructed from a main body molded from a structural plastic resin, a cap separately molded from a decoration-compatible resin, a decorative foil or film applied to the molded cap followed by the joining of the decorative cap to the main body.

FIGS. 2a-2f are schematic illustrations of the new method of producing a decorative structural plastic part in accordance with the teachings of this document requiring only the molding of the integral plastic part body followed by the application of a decoration to the decoration-compatible layer of the integral plastic part body.

FIG. 3 is a perspective view of an air register for a motor vehicle including a plurality of louvers or vanes that may be efficiently and effectively produced utilizing the method disclosed in this document.

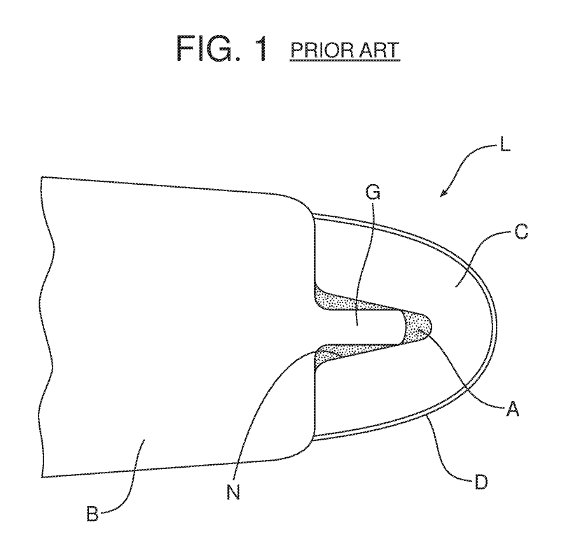

Reference will now be made in detail to the present preferred embodiments of the method, examples of which are illustrated in the accompanying drawing figures.

### DETAILED DESCRIPTION

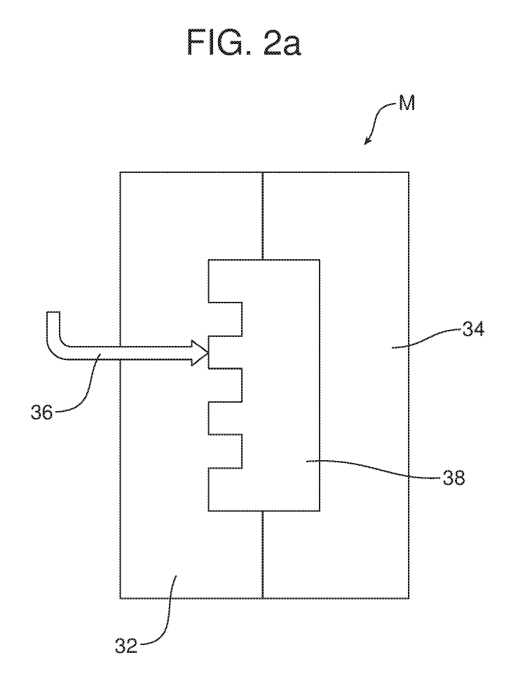

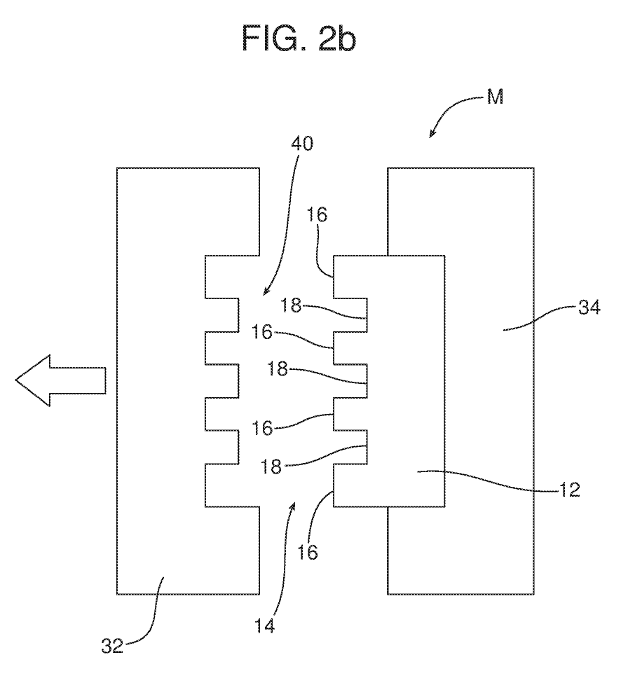

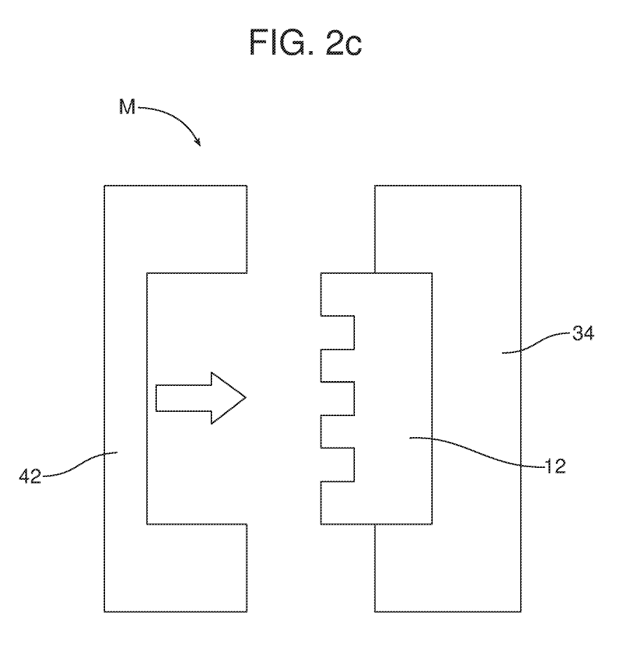

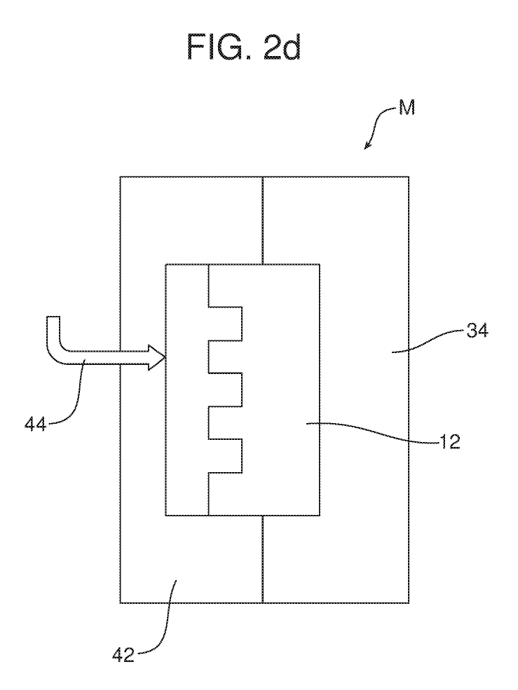

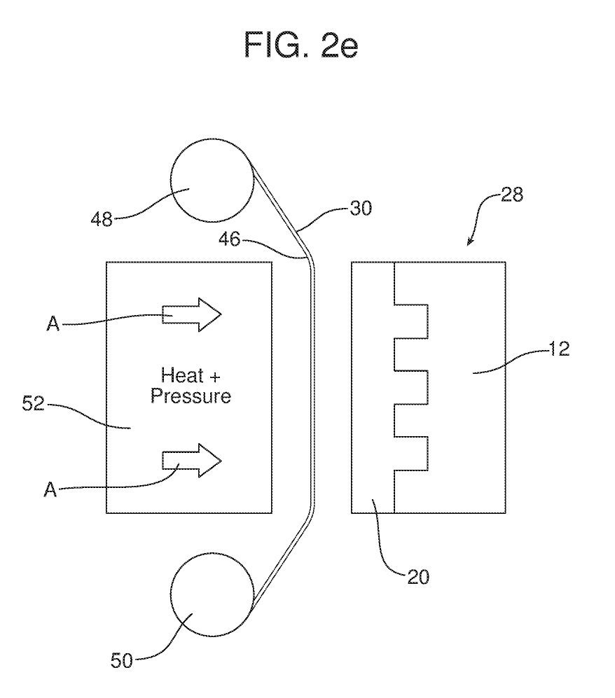

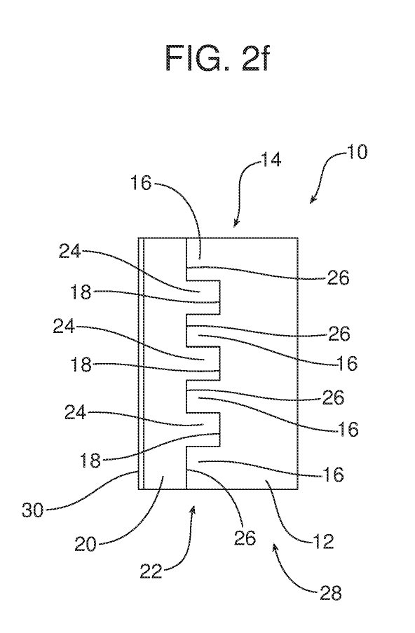

Reference is now made to FIGS. 2a-2f illustrating a new and improved method for producing a decorative structural plastic part 10. As best illustrated in FIG. 2f, that decorative structural plastic part 10 includes a structural plastic layer 12 with a first set 14 of alternating projections 16 and channels 18. The decorative plastic part 10 further includes a decoration-compatible plastic layer 20 including a second, complementary set 22 of alternating projections 24 and channels 26. As illustrated, the first and second sets 14, 22 of complementary alternating projections 16, 24 and channels 18, 26 are interdigitating to form a mechanical bond between the structural plastic layer 12 and the decoration-compatible plastic layer 20 thereby effectively forming an integral plastic part body generally designated by referenced numeral 28. In addition, the decorative plastic part 10 includes a decoration 30, such as a decorative foil or film (e.g. a metallic film) that adheres to the decoration-compatible layer 20 so as to enhance the appearance of the decorative plastic part 10.

As will be appreciated from the following description, the decorative structural plastic part 10 is produced using a method that may be generally described as comprising the steps of: (a) two-shot molding a structural plastic layer 12 with a decoration-compatible plastic layer 20, (b) mechanically bonding the structural plastic layer with the decoration-compatible plastic layer to form an integral plastic part body 28 and (c) applying a decoration 30 to the decoration-compatible plastic layer following molding. As illustrated in FIG. 2a, a mold M for forming the decorative plastic part 10 includes a first mold section 32 and a second mold section 34 that are closed together. A structural plastic resin 36 is injected into the closed mold M to form the structural plastic layer 12 in the cavity 38 formed by the two mold sections 32, 34.

After the requisite amount of curing, the mold M is opened with the structural plastic layer 12 retained in the second mold section 34 (see FIG. 2b). As should be appreciated, the first mold section 32 includes a mold cavity portion 40 shaped and adapted to form the first set 14 of alternating projections 16 and channels 18 in the structural plastic layer 12.

As illustrated in FIG. 2c, the first mold section 32 is now replaced with a third mold section 42 which is closed over the structural plastic layer 12 against the first mold section 34 of the mold M. This is followed by the injecting of a decoration-compatible plastic resin 44 between the structural plastic layer 12 and the third mold section 42 (see FIG. 2d). Since the structural plastic layer 12 is made from a resin having a higher softening point temperature than the decoration-compatible resin 44 used to form the decoration-compatible plastic layer 20, the first set 14 of alternating projections 16 and channels 18 on the structural plastic layer functions as a mold profile for forming the second set 22 of alternating projections 24 and channels 26 in a complementary pattern in the decoration-compatible plastic layer 20. Accordingly, the mechanical bond is formed by the interdigitating projections or fingers 16, 24. As a result, an integral plastic part body 28 is molded in the mold M. That body 28 includes the structural plastic layer 12 and the decoration-compatible plastic layer 20.

The mold M is then opened and the integral plastic body 28 is removed from the mold. Next, as illustrated in FIG. 2e, is the applying of a decoration 30 to the decoration-compatible plastic layer 20. As illustrated in FIG. 2e, that decoration 30, such as a decorative foil or film, is fed on a carrier 46, such as a continuous backing or web, from a feed roll 48 to a takeup roll 50. An application head 52 on the web side is advanced (note action arrows A) toward the decoration-compatible plastic layer 20 and applies the necessary heat and pressure to transfer the decoration 30 from the web carrier 46 onto the face of the decoration-compatible plastic layer 20 thereby completing the decorative plastic part as illustrated in FIG. 2f.

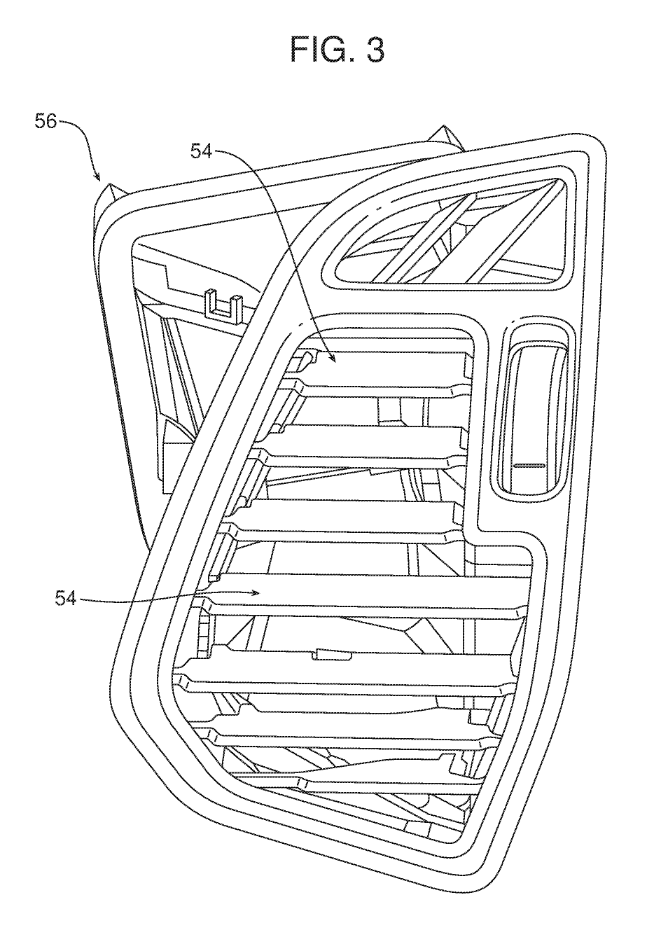

In one particularly useful embodiment, that decorative structural plastic part 10 comprises the louvers or vanes 54 of an air register 56 such as found on a motor vehicle. See FIG. 3 illustrating the air register 56.

The foregoing has been presented for purposes of illustration and description. It is not intended to be exhaustive or to limit the embodiments to the precise form disclosed. Obvious modifications and variations are possible in light of the above teachings.

For example, the order of injecting the structural plastic resin 36 and decoration-compatible resin 44 may be reversed where the structural plastic resin has a lower softening point temperature than the decoration-compatible resin. Thus, the method may include the steps of: (a) injecting a decoration-compatible plastic resin 44 into the mold M to form the decoration-compatible plastic layer 20, (b) injecting the structural plastic resin 36 into the mold against the decoration-compatible plastic layer to form the structural plastic layer 12 and the integral plastic part body 28, and (c) removing the integral plastic part body from the mold before applying the decoration 30 to the decoration-compatible plastic layer. Further, it should be appreciated that the mechanical bond 18 may take another form such as holes in the structural plastic layer 12 which receive locking posts of the decoration-compatible plastic layer 20.

All such modifications and variations are within the scope of the appended claims when interpreted in accordance with the breadth to which they are fairly, legally and equitably entitled.

What is claimed:

1. A method of producing a decorative structural plastic part, comprising:
two-shot molding a structural plastic layer with a decoration-compatible plastic layer;
mechanically bonding said structural plastic layer with said decoration-compatible plastic layer to form an integral plastic part body; and
applying a decoration to said decoration-compatible plastic layer following molding.

2. The method of claim 1, including injecting a structural plastic resin into a mold to form said structural plastic layer.

3. The method of claim 2, including injecting a decoration-compatible plastic resin into said mold against said structural plastic layer to form said decoration-compatible plastic layer and said integral plastic part body.

4. The method of claim 3, including removing said integral plastic part body from said mold before applying said decoration to said decoration-compatible plastic layer.

5. The method of claim 4, including using heat and pressure to apply said decoration to said decoration-compatible plastic layer.

6. The method of claim 1, including injecting a decoration-compatible plastic resin into a mold to form said decoration-compatible plastic layer.

7. The method of claim 6 including injecting a structural plastic resin into said mold against said decoration-compatible plastic layer to form said structural plastic layer and said integral plastic body part.

8. The method of claim 7 including removing said integral part body from said mold before applying said decoration to said decoration-compatible plastic layer.

9. A method of producing a decorative plastic part, comprising:
closing a mold including a first mold section and a second mold section;
injecting a structural plastic resin into said closed mold to form a structural plastic layer;
opening said mold while retaining said structural plastic layer in said second mold section;
replacing said first mold section with a third mold section and closing said third mold section against said second mold section;
injecting a decoration-compatible plastic resin into said mold between said structural plastic layer and said third mold section to form an integral plastic part body including said structural plastic layer and a decoration-compatible plastic layer;
mechanically binding said structural plastic layer with said decoration-compatible plastic layer during molding;
opening said mold;
removing said integral plastic part body from said mold; and
applying a decoration to said decoration-compatible plastic layer after said integral plastic part body is removed from said mold.

10. The method of claim 9, including forming a mechanical bond between said structural plastic layer and said decoration-compatible plastic layer by providing a first set of alternating projections and channels on a first face of said structural plastic layer.

11. The method of claim 10, including forming a second set of alternating projections and channels on a second face of said decoration-compatible plastic layer.

12. The method of claim 11, including interdigitating said first set of alternating projections and channels with said second set of alternating projections and channels.

13. The method of claim 12, including molding said structural plastic layer from a structural plastic resin selected from a group consisting of 50% glass-filled polyamide 6, 60% glass-filled polyamide 6, 50% glass-filled polyamide 66, 60% glass-filled polyamide 66, 55% glass-filled polybutylene terephthalate or mixtures thereof.

14. The method of claim 13, including molding said decoration-compatible plastic layer from a decoration-compatible resin selected from a group consisting of acrylonitrile butadiene styrene, polycarbonate+acrylonitrile butadiene styrene, acrylonitrile styrene acrylate or mixtures thereof.

15. The method of claim 14, including using a decorative foil as said decoration.

16. The method of claim 14, including using a decorative film as said decoration.

17. The method of claim 14 including using a metallic foil as said decoration.

18. The method of claim 14 including using a metallic film as said decoration.
